(19) United States
(12) Patent Application Publication
(10) Pub. No.: US 2009/0066509 A1
(43) Pub. Date: Mar. 12, 2009

(54) UNIFORM ARCHITECTURE FOR PROCESSING DATA FROM OPTICAL AND RADIO FREQUENCY SENSORS

(75) Inventors: Torulf Berndt JERNSTROM, Helsiniki (FI); Janne Paavo Ristoppi Jalkanen, Espoo (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/851,781

(22) Filed: Sep. 7, 2007

(51) Int. Cl. G08B 13/14

(52) U.S. Cl. 340/568.1

(57) ABSTRACT

A method and apparatus for capturing and processing bar code and RFID data by a uniform architecture contained in a mobile device including a combined bar code and RFID reader. The bar code data is captured by a sensor included in the mobile device. The RFID data is received from a module after interrogation by a RFID reader. The signals from the sensor are translated into digitized data having a first data format and a first identifier indicative of the first data format. The reader translates the RFID data into a second data format including a second identifier indicative of the second data format. The digitized data in the first or second data format is parsed to match a record layout of a common data format. The matched digitized data in the first or second data format is re-formatted into the common data format and passed to an application in the mobile device or to an external application in a network.

### BACKGROUND

### Field

The embodiment disclosed relates to data processing system, methods, apparatus and computer program products. More particularly, the embodiment relates to a uniform architecture for processing data from optical and radio frequency sensors for combined barcode and radio frequency readers.

### BACKGROUND

Optical bar code readers and Radio Frequency-Identification (RF-ID) readers identify objects and take other actions. An optical bar code reader illuminates a bar code on an object and detects light reflected from the bars and spaces of a code. The detected signal is transmitted to a processor for decoding and further processing. An RF-ID reader interrogates a tag attached to or included in an object for information stored in the tag. The information is descriptive of the object. The tag generates and transmits a signal to the RF-ID reader in response to the interrogation signal. The signal contains the stored information in the tag. The RF-ID reader processes and stores or passes the received information to an application or a network for further processing.

Optical bar code readers and RF-ID readers maybe combined and contained in a mobile phone or like device. Several manufacturers provide combined optical bar code—RF-ID readers including the Nokia N 93, Espoo, Finland; Di-400—Diagnostics Instruments, Livingston, England, and Sabre 1555 Scanner—Intermec, Everett, Wash., USA.

A combined optical bar code-RF-ID reader can be used for different bar code formats including Data Matrix, Quick Response (Q/R), Universal Product Code and in a Near Field Communication (NFC) environment which is a short-range connectivity technology that provides contact less connectivity between electronic devices. The NFC short-range wireless connectivity is promoted by the NFC Forum, Wakefield, Mass., which supports implementation and standardization of NFC technology. The NFC Forum has adopted the Java Specification Request (JSR) 257 as an application programming interface for contactless communication. The JSR 257 API provides separate data processing paths for bar code and RFID data in a combined bar code -RFID reader, as will be described in FIG. 2, hereinafter.

### SUMMARY

The example embodiments provide a method, apparatus and computer program product implemented in a uniform architecture responsive to optical and radio frequency sensors for barcode-readers and radio frequency reader combined in a portable or handheld device, e.g. a mobile phone. In one embodiment, electrical signals generated from a scanning device and representative of an object including a description thereof are received at a first terminal in the device. The electrical signals are read and digitized into a first data format including a first identifier indicating the first data format. The digitized data in the first data format including the first identifier is stored in a memory for subsequent data processing. Digitized data in a second data format is received at a second terminal of the device. The digitized data is representative of another object including a description thereof and a second identifier indicative of the second data format. The digitized data in the second data format including the second identifier is stored in the memory for further processing. The digitized data in the first or second data format is validated in a processor by comparison of the digitized data to a standardized data format corresponding to the first or second identifier for the related digitized data. The processor determines if the digitized data matches the standardized data format for the identifier and continues the processing of the digitized data if matched to the standardized data format or terminates processing if the digitized does not match the standardized data format. A common data format, e.g. the Near Field Communication Data Exchange Format (NDEF) is stored in the memory. The digitized data in the first or second data formats is parsed to match a record layout of the common data format. The processor reforms the digitized data in the first or second data format into the common data format; and transmits the digitized data of the bar-code or RF-ID readers in the common data format to storage or for use in an application or a network. The digitized data will be suitable for use in a Short Message Service (SMS) or Instant Messaging (IM) or a Vicinity Card (VC) card or other applications.

### DESCRIPTION OF THE DRAWINGS

The exemplary embodiments will be described in conjunction with the appended drawing, in which:

FIG. 1 is a representation of a mobile device for processing optical and RF sensor data in a Near Field Communication (NFC) environment for automatic identification and data capture of objects and incorporating the principles of the present embodiment;

FIG. 1A is a representation of a data processing architecture for a combined bar-code and Radio Frequency- Identification (RF-ID) included in the mobile device of FIG. 1;

FIG. 1B is a partial listing of software in the architecture of FIG. 1A for implementing the processing of optical and RF sensor data;

FIG. 2 is a flow diagram of a current process for processing optical and RF sensor data;

FIG. 3 is a representation of a tag containing data for use in the system of FIG. 1A;

FIG. 3A is a representation of a data format for the data stored in the tag of FIG. 3:

FIG. 4 is a representation of a Universal Product Code (UPC) and Electronic Article Number (EAN) codes for providing electrical signals from scanning an object for automatic identification and data capture;

FIG. 4A is a representation of a Quick Response pattern of data for automatic identification and data capture;

FIG. 5 is a representation of a record layout for a common data format in the NFC environment for use in FIG. 1, and

FIG. 6 is a flow diagram for processing optical and sensor data in the architecture of FIG. 1A and using the record layout of FIG. 5.

### DETAILED DESCRIPTION

Before describing an exemplary embodiment of a combined barcode- RF-ID reader with a uniform architecture, it is believed appropriate, as background, to describe a current architecture for a combined barcode and RF-ID reader.

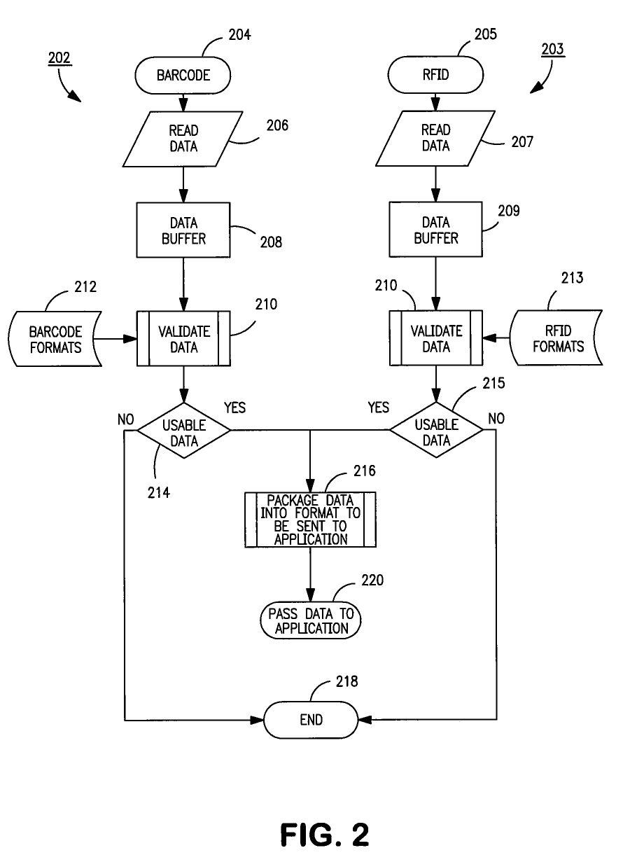

Referring to FIG. 2, a bar code data path 202 receives bar code data in block 204. The bar code data is read in block 206 and stored in a data buffer in block 208. The data is validated in block 210 by matching the received data to a bar code specification, e.g. UPC standard, Quick Response (Q/R), Universal Product Code (UPC) in block 212. The validated data is tested for usability in block 214. A “yes” directs the data to a bar code parser in block 216. A “no” condition for the test 218 ends the process. The barcode parser 216 receives a textual, numeric or binary string and places the validated data into a data format for an application, according to the parsed bar code. The formatted data is passed to the application in block 220.

In like manner to the bar code data processing, RFID data in a path 203 is received at block 205, read in block 207, and stored in block 209. The data is validated in block 211 by matching to an RFID format 213, including Electronic Product Code (EPC) 1, International Standards Organization (ISO) 15693 and Electronic Article numbering (EAN) 128. The validated data is tested in block 215. If the data is not found useable the process ends at block 218. If usable, a RF-ID parser receives the data as a textual, numeric, binary string and formats the data according to the JSR 257 specification for an application in block 216. The formatted data is passed to an application in block 220.

Currently, a combined barcode—RF-ID reader requires different parsers and different architectures for processing sensor data. The present embodiment provides a uniform architecture using a single parser and a common data format based on the Near Field Data Exchange Format (NDEF). The uniform architecture will avoid companies having to build and maintain two different architectures and skill sets. The uniform architecture will also make clear to companies building services around the bar-code and RF sensor technologies, how to implement their designs.

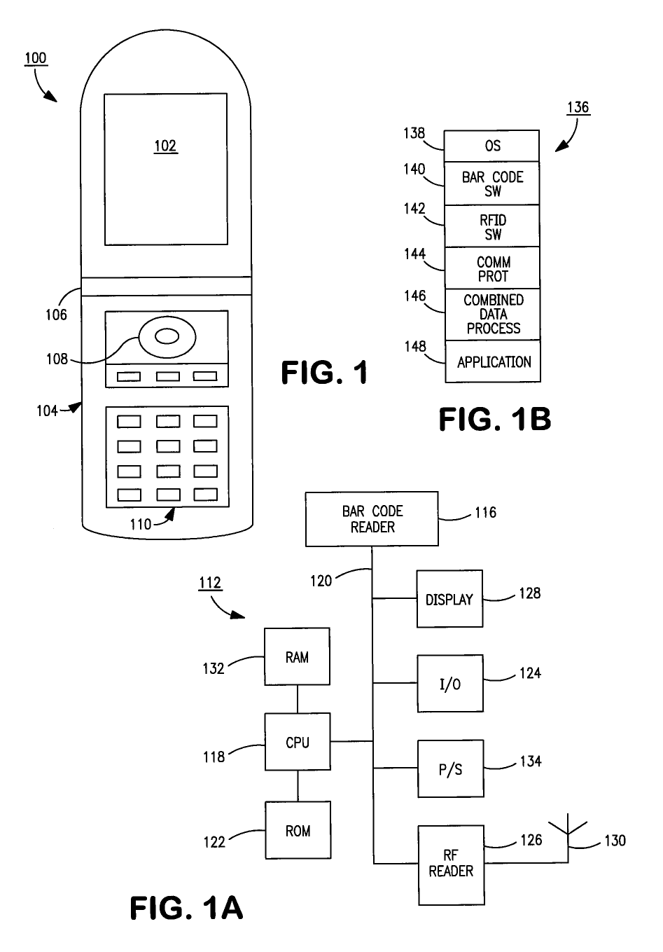

Now referring to FIG. 1, a combined barcode-RF-ID reader 100 is disclosed based on a uniform data processing architecture serving all sensors with a single parser and using a common data format, e.g. the NDEF format. The combined bar-code—RFID reader is included in a mobile device 100, e.g. a Nokia phone. The phone includes a bar-code reader sensor 102, e.g. a camera attached to a keyboard 104 via a swivel joint 106 which enables the sensor screen to be rotated to different positions. The back of the camera serves as a lid for the phone. The keyboard includes a 5-way scroll or navigation key 108, selection keys 110 including a menu key, edit and clear keys, call and end keys.

FIGS. 1A and 1B describe a uniform architecture including circuitry 112 and software 136 for processing optical or bar-code signals and RF signals for automatic identification and data capture of objects in a retail or other environment. In FIG. 1A, a bar-code reader 116 receives data signals from an optical sensor 102 scanning an object (not shown). The sensor 102 may be any bar code reader including a light source, a lens and a photo conductor translating optical impulses into electrical impulses. The optical sensor may be pen, laser, and charge controlled device (CCD), video based and the like.

In one embodiment, the sensor uses CCD devices as a camera to record an image of an object. Instead of having a single row of CCD devices, the camera has hundreds of rows of sensors arranged in a two dimensional array to capture image signals from the sensors representative of a bar code. A processor 118 connected to a buss bar 120 receives the camera data and stores the digitized camera data for further processing in a Read Only Memory (ROM) 122 coupled to the processor, as will be described herinafter.

Input/Output circuitry 124 is coupled to the buss bar 120 for processing signals entered by a user from the key board 104 for operating the bar code reader an associated decoder (not shown) and a RFID reader 126.

A display circuit module 126 is coupled to the buss bar and is responsive to the processor for controlling the camera 102 in displaying and capturing bar codes on objects.

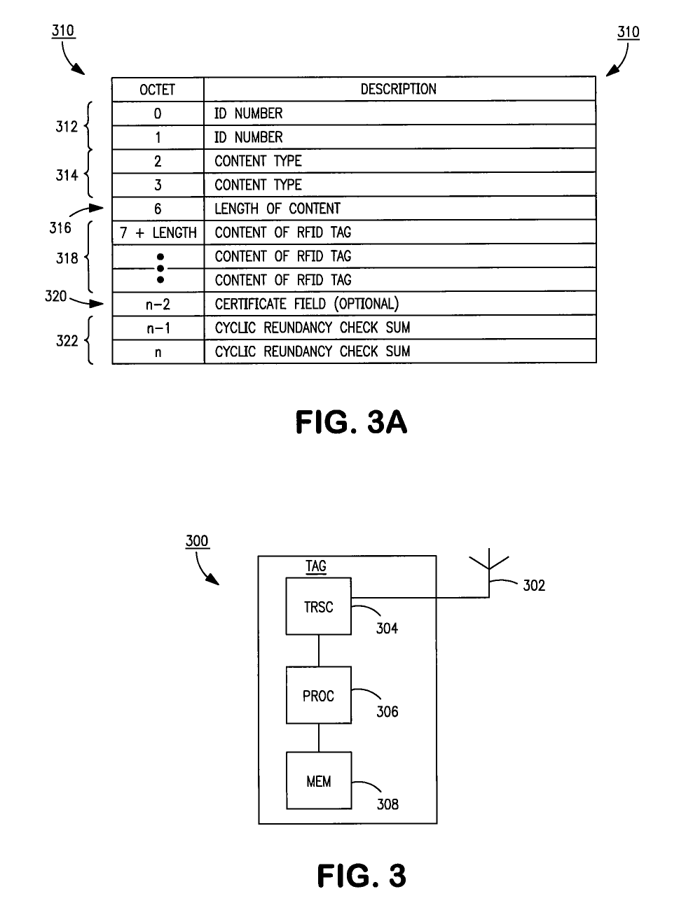

A RF-ID Reader 128 is coupled to the bus bar 120 and transmits interrogation signals via antenna 130 to tags (See FIG. 3) within a defined coverage area of the reader. The tags contain information which can be data descriptive of an object to which it is attached. The descriptive information includes an identifier and data for subsequent processing purposes. The tag in response to the interrogation signals generate and transmit digitized data to the RFID reader which stores the information or transmits the digitized data to an application or transmits the digitized data to a network via a wireline or wireless connection (not shown).

A random access memory (RAM) 132 is linlked to the processor 118 and stores the software implementing computer operations of capturing and identifying bar-code and tag data for objects in retail or other environment. A power supply 134 provides energy for operating the combined bar-code and RF-ID reader 100.

FIG. 1B describes software 136 for operating the combined bar-code and RF-ID reader. A standard operating system 138 provides program instructions for managing the operations of the processor and peripherals and apportioning the ROM and RAM for storing data and programs.

Commercially available software programs for bar-code reading 140 are stored in the RAM 132 for operation of the bar code reader 116, after identification of the bar code type by reading an identifier in the bar code data. A number of bar code type software are available including Universal Product Code (UPC), Electronic Article Numbering (EAN), Quick Response (QR),

Commercially available software programs for RF-ID systems 142 are stored in the RAM 132 for operating the RF Reader 126, after identification of the RF-ID data format by reading an identifier in the tag data. A number of tag processing software are available, including International Standards Organization (ISO) 15593; Electronic Product Code (EPC) 1.3, NFC NDEF and UCC/EAN GTAG.

Standard communication protocols 144 are stored in the RAM 132 for short-range and cellular communication via antennas (not shown) for wireline and wireless communication with external networks.

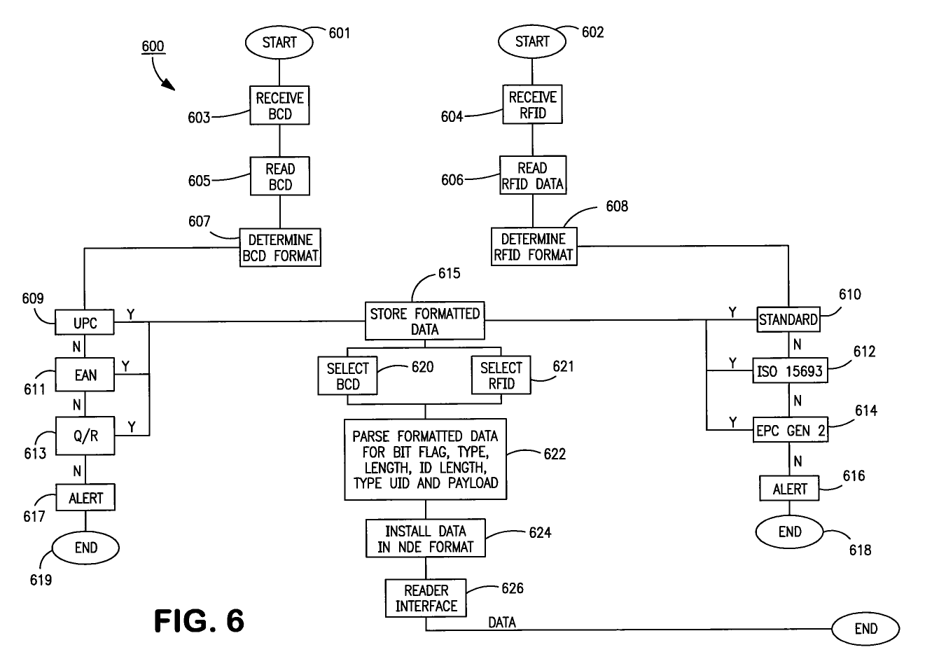

A data processing program 146 for implementing a unified architecture is stored in the RAM 132 and will be described in conjunction with FIG. 6.

Applications 148 for Short Messaging Service (SMS), Instant Messaging (IM), Vicinity Card (VC) and other like applications are stored in the RAM 132 for operation using identified bar codes and tags.

Turning to FIG. 3, RFID technology utilizes electromagnetic or electrostatic coupling in the radio frequency (RF) portion of the electromagnetic spectrum, typically 125 kHz, 134.2 kHz, and 13.56 MHz. for short range communication and up to 2.45 GHz for long range (8-10 meters) communication. An RF interrogation signal is transmitted from the RFID reader 126 to a tag 300 for activating the tag in either a short range or long range mode of operation. An antenna 302 is included in the tag for capturing the interrogation signals transmitted by the reader 126 (FIG. 1) when within the coverage area of the reader transceiver. The antenna 302 is coupled to a transceiver 304 in the tag 300.

A processor 306 is coupled to the transceiver 304 for processing signals transmitted by the reader 126 and generating a response signal to the interrogation signal based on information stored in a memory 308 coupled to the processor 306.

When a tag has been activated, information in the memory 308 is transmitted back to the RFID reader 126 (FIG. 1). In the case of a passive tag, the tag may be energized by a time-varying electromagnetic RF wave generated by the RFID reader 126. When the RF field passes through the antenna coil associated with the tag, a voltage is generated across the coil. This voltage is ultimately used to power the tag, and make possible the tag's return transmission of information to the reader, sometimes referred to as backscattering. Using this information, the RFID reader 126 can direct the mobile device 100 to perform an action identified from the received information. One advantage of RFID is that it does not require direct contact, although direct contact with an RFID tag can occur, and in some instances may be required. The frequency employed will at least partially dictate the transmission range of the reader/tag link. The required proximity of the mobile device 100 to a tag can range from a very short range (touching or near touching) to many meters, depending on the frequency employed and the power output reader transceiver.

Any type of RFID tag may be used in connection with the present embodiment. RFID tags can be either passive or active. Passive tags, as in the present instance, do not require a dedicated power source, but rather obtain operating power generated from the reader 126 transmission. Active tags require an internal battery and are often read/write tags. Further, tags may come in a variety of shapes and sizes, but are generally based on a custom designed silicon integrated circuit. Any transponder/tag may be used in connection with the present embodiment. The tag type, size, etc. depends on the particular environment and the purpose of reading the tag.

FIG. 3A describes standard information 310 stored in the tag memory tag 308 by bytes for identifying the object to which tags for various items may be attached. The information block 310 includes an identifier 312 comprising two bytes of information reserved for an identifier (ID NUMBER). The block 310 provides a content type 314, which defines the type of content that is provided via the tag 300. The content types may include SMS, Multi Media Messaging (MMS), and Uniform Resource Locator (URL) for use with Wireless Application Protocol (WAP) browsing, Java program download request and/or Java programs (e.g., MIDlets), UPC/EPC, smart message, and the like. Each of these and other content types can be identified via the content type field 314.

The information block 310 may also include a content length field 316 which indicates the length of the content 318 portion of the tag information. Representative types of content that can be included as content 318 in the tag information 310 have been previously described. An optional certificate field 320, illustrated as one octet but of any desired length, may be provided. The field 320 may be used to provide an electronic signature to guarantee authenticity of a service provider, from which the user may access the public key location and verify the signature based on Public Key Infrastructure (PKI) policies. A check sum field 322, such as Cyclic Redundancy Check (CRC) field, may also be provided with the tag information 300. The CRC information may be used error checking the tag information. Other and/or different information may also be provided in different tag content types, formats, fields, etc.

The RF tag data may appear in several RF formats including Joint Test Action Group (JTAG) RF-Tag Data format, Version 2; Electronic Product Code (EPC) Gen 2 and International Standards Organization (ISO) 15693.

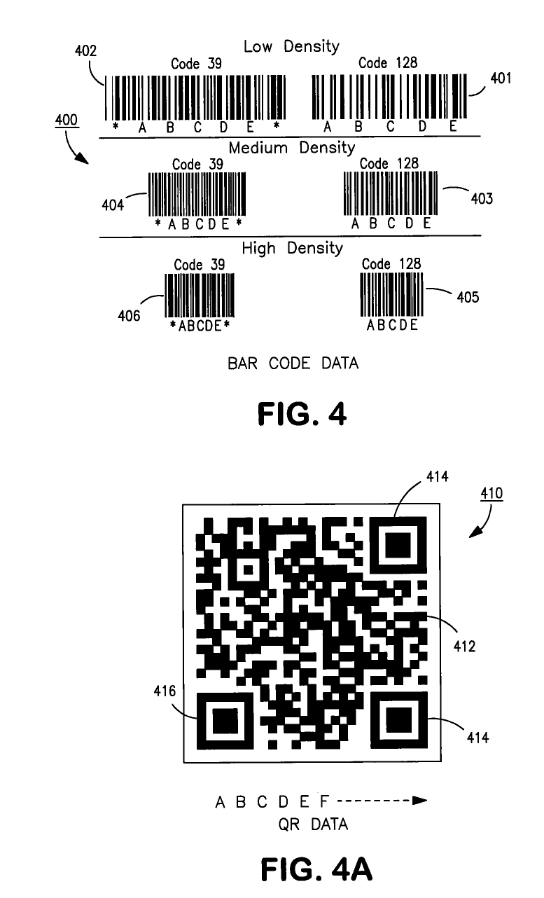

FIG. 4 describes representative Universal Product Codes (UPC) code 39 and Electronic Article Number (EAN) code 128 formats, which may be scanned and processed by the barcode reader 116 (FIG. 1). The code 39 format is shown in low density 402, medium density 404 and high density 406 formats. Code 39 has nine bars and spaces, 3 bars are wide and 6 are narrow. Likewise, the EAN code 128 is stored in low density 401, medium density 403 and high density 405 formats. EAN 128 has four widths applicable in combinations to all 128 ASCII characters.

Each of the sensing devices in the camera 102 (FIG. 1) is vertically aligned with an object on which is located a plurality of dot matrix printed coded bars. Each of the sensing devices is positioned so as to sense one of the matrix dots which form the coded bar and output an analog signal whose signal level varies directly in accordance with the ink intensity of the sensed dot. Signals are then amplified, filtered and converted to digital signals which are then examined. If a predetermined number of dots in the bar have been sensed and of the dots sense, no more than two dots are found to be separated by more than one blank space where a dot would normally be located, a signal is generated indicating that a valid bar has been sensed. These signals are then used by a decoder (not shown) associated with the bar-code reader in decoding the bars sensed and communicating the decoded bar codes as digitized data to a processor.

FIG. 4A describes a Quick Response (QR) barcode 410, which is a two-dimensional general-purpose matrix. The QR code carries QR symbols horizontally and vertically. The symbols are contained in module 412 shown in black The barcode is scanned 360 degrees using postion detection paterns 414 at the matrix corners.

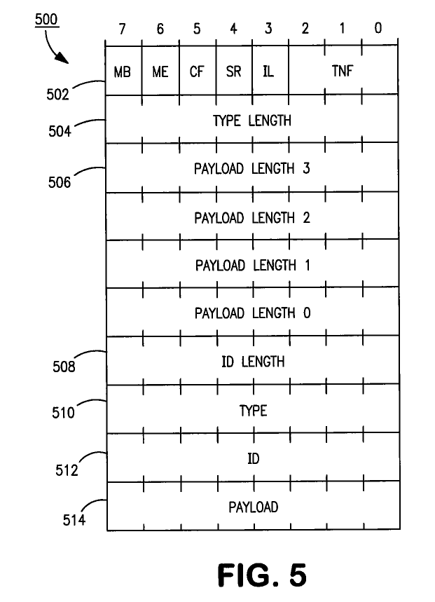

FIG. 5 shows the NFC Data Exchange Format (NDEF) 500 which in the present instance serves as a common data format for receiving bar code and RF-ID data in various data formats, as will be described in conjunction with FIG. 6. The NDEF 500 is described in the NDEF Technical Specification (NFCForum-TS-NDEF_{—}1.0), available from the NFC Forum, Wakefield, Mass. The format is a lightweight message format designed to encpsulate small payloads ranging between 0 and 255 octets.

A first octet 502 contains bit flags: MB=Message Begin; ME=Message End; CF=Chunk Flag; SR=Short Record; IL=ID Length Field Present; TNF=Type Name Format.

A Type Field 504 is an unsigned 8-bit integer that specifices the length in octets of the ID field.

A Payload Length Field 506 is an unsigned integer that specifies the length in octets of a Payload field. If the SR flag is set, the Payload Length is a single octet if the SR flag is clear, the Payload Length is four octets.

An ID length Field 508 is an unsigned 8-bit integer that specifies the length of an ID field in octets.

A Type Field 510 is an identifier describing the type of the payload.

An ID Field 512 is an identifier in the form of a Uniform Resource Locator (URL).

A Payload Field 514 carries the payload intended for a user application.

The NFC data need not be or have a payload that describes the item to which it is attached. The NFC data can contain a phone number, a URL for web browsing, a business card, a travel card, a discount voucher, or any of the data formats defined. In such instances it is the association of the tag with an object such as an advertisement for which the phone number or the URL is provided.

Referring to FIG. 6, a program 600 processes data from bar code and RFID readers into a common data format executable by applications stored in a communicating device, e.g a mobile device 100 (See FIG. 1). The program uses a single parser and is initiated by the mobile device for bar code or RF-ID data data processing beginning at a start block 601 or 602, respectively.

Bar code data scanned by a reader in the device 100 is received at a terminal represented by a block 603. The bar code data is read in a block 605. The bar code data format is determined in block 607 from reading the identifier. The bar code data is compared succesively to different bar code data formats UPC, EAN, Q/R, etc in blocks 609, 611, and 613, respectively, until a match occurs between a format and the bar code data. When a match occurs, the data is formatted according to the format specification and stored in a memory represented by block 615. If none of the bar code formats apply, a user is alerted to the presence of erroneous data in block 617 and the program ends in block 619.

In like manner, RFID data is received by an RFID reader in block 604; read by the reader in block 606 and the format determined in block 608 by comparing the RFID tag data to the various tag formats including standard tag data described in FIG. 3A; ISO 15693 and EPC Gen 2 formats in blocks 610, 612 and 614. When a match occurs between the RFID data and the comparing format, the data is formatted and passed to the memory 615. The user is alerted in block 616 and the program ends in block 618 if there is no match between the RFID data and the formats.

An NDEF parser is included in the program 600 and selects either formatted bar code data in block 620 or RFID data in block 621 for processing. The NDEF parser parses or deconstructs the NDEF message by transforming input text into a data structure, usually a tree, using well-known parsing routines and hands off the payload to an application.

The selected formatted data is parsed in block 622 for the common data fields NDEF fields, including bit flags; type length; payload length; ID length; Type; ID amd Payload, as described in FIG. 5. The parsed data is installed in the common data format in block 624 and passed to an application via a reader interface 626. The application may be stored in the mobile device 100 or in a network accessed by the mobile device using the communication protocols stored in the RAM 132 (FIG. 1A).

The bar code data and the RFID data included in the common data format may contain an indentifier and related content. The identifier identifies and initiatees an application on the Mobile phone. The reader feeds the content to another application on the mobile device which may be a Short Messaging Service (SMS) application. When the SMS application is invoked, a SMS message is sent to the service provider. In like manner, applications may be invoked for Instant Messaging, Vicinity Card, Multi-Media Messaging.Service (MMS).

In another embodiment, the digitized data in the common data format may contain FM radio or TV tuner data indicated in the Type field 516 of FIG. 5. The payload 514 would contain the frequency of the broadcast signal. The data would be parsed according to FIG. 6 and at the interface 626, the identified frequency would be passed to an application and related hardware (FM or TV tuner).

In another embodiment, the digitized data in the common data format may contain satelite station settings or parameters in the payload, identified n the Type Field 510 (FIG. 5) and after parsing of the data by the uniform architecture, passed to an application serving a satelite network.

In another embodiment, the digitized data in the common data format may contain vicinity card information in the payload, described in the Type field, for importation into a contact file in the memory.

In another embodiment the digitized data in the common data format may contain instructions in the payload, described in the Type field, for launching a software application stored in the memory.

The foregoing description of an exemplary embodiment has been presented for the purposes of illustration and description. It is not intended to be exhaustive or to limit the embodiment to the precise form disclosed. Many modifications and variations are possible in light of the above teaching. For example, it will be apparent to those skilled in the art from the foregoing description that the embodiment is equally applicable to optical sensing devices of all types; RF-ID devices for short range and long range communication; mobile or stationary devices and other current or future radio frequency identification technologies using, for example, electromagnetic/electrostatic coupling, and thus the present embodiment is not limited to “RFID” or bar-code technology as these terms are currently used. It is intended that the scope of the embodiment be limited not with this detailed description, but rather by the claims appended hereto.

1. A method, comprising:
a) translating electrical signals from a scanning device into digitized data having a first data format and a first identifier indicative of the first data format;
b) translating digitized data into a second data format including a second identifier indicative of the second data format;
c) storing a common data format;
d) parsing the digitized data from instructions in the first or second data format to match a record layout of the common data format; and
e) reforming the digitized data in the first or second data format into the common data format.

2. The method of claim 1 further comprising passing the digitized data to an application.

3. The method of claim 1 further comprising using a single parser to parse the digitized data in the first and second data formats.

4. The method of claim 1 further comprising:
validating and formatting the digitized data by comparing the first and second data formats to standard data formats for the first and second data formats.

5. The method of claim 1 further comprising determining if the formatted digitized data is usable.

6. The method of claim 1 further comprising including a code in the first or second digital formats to identify an object.

7. The method of claim 1 further comprising: storing together digitized data in the first and second formats in a memory

8. The method of claim 1 further wherein the digitized data in the first format is bar code data.

9. The method of claim 1 wherein the digitized data in the second format is RF data.

10. The method of claim 1 wherein the common data format is described by the Near Field Communication Data Exchange Format (NDEF).

11. Apparatus, comprising:
a processor configured to:
i) translate first signals from a scanning device and store in a memory digitized data having a first data format and a first identifier indicative of the first data format;
(ii) translate second signals from a RF module and store in the memory digitized data in a second data format including a second identifier indicative of the second data format;
(iii) store a common data format in the memory;
(iv) parse the digitized data from instructions in the first or second data format to match a record layout of the common data format; and
(v) reform the digitized data in the first or second data format into the common data format.

12. The apparatus of claim 11 further comprising a sensor for reading bar code information and providing the first signals to the processor for conversion into digitized data.

13. The apparatus of claim 11 further comprising a RF-ID module storing digitized data in the second format and responsive to an interrogation signal for transmitting the second signals to a receiver.

14 The apparatus of claim 11 further comprising a reader for transmitting the interrogation signal to the RF-ID module and receiving the second signals as digitized data from the RF-ID module for storage or distribution to an application in the apparatus or to a network.

15. The apparatus of claim 11 further comprising a single parser for parsing the first signals as bar code data and the second signals as RF-ID data into the common data format.

16. The apparatus of claim 11 wherein the common data format is described by the Near Field Communication Data Exchange Format (NDEF).

17. The apparatus of claim 11 wherein an application is stored in the memory for short message service using the digitized data stored in the memory in sending and receiving short messages.

18. The apparatus of claim 11 wherein an application is stored in the memory for instant message service using the digitized data stored in the memory for instant messaging.

19. The apparatus of claim 11 wherein the digitized data stored in the memory is provided as tuning data to an application serving RF receivers.

20. The apparatus of claim 11 wherein the digitized data stored in the memory is provided as satellite settings or parameters to an application serving a satellite network.

21. The apparatus of claim 11 wherein the digitized data stored in the memory describes vicinity card for importation into a contact database in the memory.

22. The apparatus of claim 11 wherein the digitized data stored in the memory contains instructions for launching a software application.

23. A medium containing program instructions, executable in a computer system, comprising
a) program instructions for translating first signals from a scanning device into digitized data having a first data format and a first identifier indicative of the first data format;
b) program instructions for translating second signals from a first module into a second data format including a second identifier indicative of the second data format;
c) program instructions for storing a common data format;
d) program instructions for parsing the digitized data in the first or second data format to match a record layout of the common data format; and
e) program instructions for reforming the digitized data in the first or second data format into the common data format.

24. A method, comprising:
a) receiving at a first terminal first signals generated from a scanning device and representative of an object including a description thereof;
b) reading and digitizing the first signals into a first data format including a first identifier indicating the first data format of the digitized data;
c) storing the digitized data in the first data format including the first identifier in a memory for subsequent data processing;
d) receiving and digitizing at a second terminal second signals data in a second data format representative of another object including a description thereof and a second identifier indicative of the second data format;
e) reading and storing in the memory the digitized data in the second data format including the second identifier for further processing;
d) validating the digitized data in the first or second data format by comparison of the digitized data to a standardized data format corresponding to the first or second identifier for the related digitized data;
e) determining if the digitized data matches the standardized data format for the identified;
f) continuing processing the digitized data if matched to the standardized data format or terminating the processing if the digitized does not match the standardized data format;
g) storing a common data format for the digitized data in the first or second data format;
h) parsing the digitized data in the first or second data formats to match a record layout of the common data format;
i) re-forming the digitized data in the first or second data format into the common data format; and
j) transmitting the digitized data in the common data format to storage or to an application or a network.

25. A portable device, comprising:
a) means for scanning bar code into digitized data having a first data format and a first identifier indicative of the first data format;
b) means for receiving BY signals as digitized data from a module, the digitized data in a second data format including a second identifier indicative of the second data format;
c) means for storing a common data format in a memory;
d) means for parsing the digitized data in the first or second data format to match a record layout of the common data format; and
e) means for re-forming the matched digitized data in the first or second data format into the common data format.

26. A method, comprising:
a) translating electrical signals from a device into digitized data having a first data format and a first identifier indicative of a common data format;
b) searching the first identifier to be indicative of the common data format,
c) extracting the digitized data representative of the common data format
d) parsing the digitized data according to a record layout of the common data format; and
e) acting upon the parsed data from the record layout of the common data format.
